(19) United States
(12) Patent Application Publication
(10) Pub. No.: US 2025/0014410 A1
(43) Pub. Date: Jan. 9, 2025

(54) VOTING SYSTEM USING TOKEN AND METHOD THEREOF

(71) Applicant: Mod haus Inc., Seoul (KR)

(72) Inventor: Junyoup HWANG, Seoul (KR)

(21) Appl. No.: 18/361,433

(22) Filed: Jul. 28, 2023

(30) Foreign Application Priority Data
Jul. 7, 2023 (KR) 10-2023-0088698

(51) Int. Cl. G07C 13/00; G06Q 20/38; G06Q 20/40

(52) U.S. Cl. CPC G07C 13/00; G06Q 20/3827; G06Q 20/389; G06Q 20/401; G06Q 2230/00

(57) ABSTRACT

The present technology relates to an electronic device, and a token voting system using a blockchain network according to the present technology may include a voting control server, a database server, a monitoring server, and a verification server. The voting control server may generate hash data based on vote data received from a user terminal in response to a voting request of the user terminal, and provide the hash data to the user terminal. The database server may store vote data, status information about the vote data, and hash data. The monitoring server may check a transaction generated by the user terminal transmitting the hash data and a token to the blockchain network, and set status information according to a transaction check result. The verification server may verify vote data stored in the database server on the blockchain network.

### CROSS-REFERENCE TO RELATED APPLICATION

The present application claims priority under 35 U.S.C. § 119 (a) to Korean patent application number 10-2023-0088698 filed on Jul. 7, 2023, in the Korean Intellectual Property Office, the entire disclosure of which is incorporated by reference herein.

### TECHNICAL FIELD

The present disclosure relates to a voting system using a token and a method thereof. More particularly, the present disclosure relates to a method and system for allowing a user to simply vote without going through a complicated process by receiving unique token identification information or uniform resource locator (URL) information of a token by a user terminal as input and using a minted token.

### RELATED ART

Blockchain refers to data management technology that records continuously increasing data in a block of a specific unit and manages a plurality of blocks in a chain-like data structure by each of nodes forming a peer-to-peer (P2P) network, or data itself having the chain-like data structure. The blockchain having the chain-like data structure may operate in the form of a distributed ledger at each node without intervention of a central system.

A blockchain-based system performs a consensus process across a network to ensure integrity and conformity of data in a distributed environment. The consensus process is carried out through processes such as block generation, block propagation, and block verification, and blockchain-based systems proposed so far perform the consensus process using consensus algorithms such as proof of work and proof of stake.

Blockchains are divided into permissionless blockchains and permissioned blockchains. A permissionless blockchain is a blockchain that allows users and nodes to participate in a blockchain network without any restrictions. A permissioned blockchain is a blockchain suitable for use in a business environment that allows only authorized users and nodes to participate in the blockchain network.

Smart contracts refer to various types of contracts such as notarization and real estate contracts that are concluded and executed based on the blockchain. The smart contracts may automatically execute requests according to business logic without intervention of a third party.

A token may be a digital asset represented on a blockchain. Tokenizing digital assets on the blockchain may provide benefits such as proof of ownership of digital assets, transparency, and liquidity guarantees. Tokens are divided into fungible tokens and non-fungible tokens. A fungible token is a token that represents a digital asset that can be divided. a non-fungible token is a token that represents a digital asset that cannot be divided, and uses blockchain technology to prove the owner of the digital asset. The non-fungible token is used to indicate its inherent originality and ownership by embedding an address that points to a digital file such as a picture or video in the token. he non-fungible token maintains its uniqueness and may be regarded as a concept similar to a national ID card of which the same product cannot exist. The non-fungible tokens are guaranteed to be unique by permanently leaving trade details on the blockchain.

The non-fungible tokens are used for various purposes such as (1) collectibles such as art and cards, (2) Profile Picture (PFP) for use as a profile picture on Social Network Service (SNS), (3) a ticket (Pass) to participate in any project, community, or performance, (4) physical (physical+digital) provided in connection with actual goods, (5) certificates proving rights such as copyright, ownership, and intellectual property rights, and (6) items, characters, and land in a game, and use of the non-fungible tokens is increasing.

In order to acquire a non-fungible token, it is required to participate in the minting of the non-fungible token, or purchase the non-fungible token that has already been minted through trade to receive the non-fungible token transmitted from the owner.

For example, (1) a user may sign up for a domestic digital asset exchange, open a bank account in his or her name to register it on the exchange, and, after customer verification is completed, deposit cash for purchasing a digital asset, i.e., a coin or token, to the exchange through the bank account. The user may purchase the coin or token listed on the exchange using cash.
(2) The user may create (or configure) a personal blockchain wallet such as Meta Mask and transmit the coin or token purchased on the exchange to be displayed in the personal blockchain wallet. When the personal blockchain wallet is created (or configured), a public key and a private key are generated, and the user who creates (or configures) the personal blockchain wallet may check the exact amount of the coin or token the user owns through interaction between the personal blockchain wallet and the blockchain. A blockchain wallet may serve as a bridge that connects a user with coins or tokens that exist on the blockchain. The user who uses the blockchain wallet can buy, sell, store, and use coins or tokens through the blockchain wallet.
(3) The user may visit a website that mints non-fungible tokens or a website that supports trade of non-fungible tokens and connect the website with the personal blockchain wallet. When the website minting non-fungible tokens is connected to the personal blockchain wallet, the user may own a non-fungible token by minting the non-fungible token or executing transactions to trade the non-fungible token. A transaction refers to the ‘smallest unit of business processing that cannot be divided’ and represents details of each trade made in the blockchain.

### PRIOR ART DOCUMENT

### Patent Document

(Patent Document 0001) Korean Patent Application Publication No. 10-2022-0135521 (published on Oct. 7, 2022)

### CONTENT OF THE INVENTION

### Problem to be Solved

A technical object to be achieved by the present disclosure is to provide a method and system for voting using a token even in case of not joining a domestic digital asset exchange or creating a personal blockchain wallet.

Another technical object to be achieved by the present disclosure is to provide a method and system for allowing a user to vote using a token minted based on information displayed on a tangible object.

### Means of Solving the Problem

A token voting system using a blockchain network in accordance with an embodiment of the present disclosure may include a voting control server, a database server, a monitoring server, and a verification server. The voting control server may generate hash data based on vote data received from a user terminal in response to a voting request of the user terminal, and provide the hash data to the user terminal. The database server may store the vote data, status information about the vote data, and the hash data. The monitoring server may check a transaction generated by the user terminal transmitting the hash data and a token to the blockchain network, and set the status information according to a check result of the transaction. The verification server may verify the vote data stored in the database server on the blockchain network.

An operating method of a token voting system using a blockchain network in accordance with an embodiment of the present disclosure may include generating hash data based on vote data received from a user terminal in response to a voting request of the user terminal; storing the vote data, status information about the vote data, and the hash data in a database server; providing the hash data to the user terminal; checking a transaction generated by the user terminal transmitting the hash data and a token to the blockchain network; and setting the status information according to a check result of the transaction.

An operating method of an electronic system comprising a user terminal, a blockchain network and a token voting system in accordance with an embodiment of the present disclosure may include providing, by the user terminal, vote data to the token voting system; generating, by the token voting system, hash data based on the vote data and salt data; storing, by the token voting system, the vote data, status information about the vote data, and the hash data; providing, by the token voting system, the hash data to the user terminal; performing, by the user terminal, a transaction for transmitting the hash data and a token to the blockchain network; storing, by the blockchain network, the hash data and the number of tokens; and checking the transaction and setting the status information according to a check result of the transaction, by the token voting system.

### Effects of the Invention

According to the embodiments, even a user who has not joined a domestic digital asset exchange or created a personal blockchain wallet may easily vote using a token.

In addition, according to the embodiments, the user may easily vote using a token minted based on information displayed on a tangible object.

### BRIEF DESCRIPTION OF THE DRAWINGS

FIG. 1 is a diagram for explaining a configuration and operation of an electronic system in accordance with an embodiment of the present disclosure.

FIG. 2 is a flowchart for explaining a voting method using an electronic system.

FIG. 3A is a flowchart for explaining a voting operation of FIG. 2 in detail.

FIG. 3B is a flowchart for explaining a vote counting operation of FIG. 2 in detail.

FIG. 3C is a flowchart for specifically explaining a vote result disclosing operation of FIG. 2.

FIG. 4A is a diagram for explaining an operation of a token voting system in a voting operation.

FIG. 4B is a diagram for explaining an operation of a token voting system in a vote counting operation.

FIG. 4C is a diagram for explaining an operation of a token voting system in a vote result disclosing operation.

FIG. 5 is a diagram for explaining vote data, salt data, hash data, and status information in accordance with an embodiment of the present disclosure.

FIG. 6 is a diagram for explaining a vote result in accordance with an embodiment of the present disclosure.

FIGS. 7A and 7B are diagrams for explaining a front side (FIG. 7A) and a back side (FIG. 7B) of a tangible object (physical card) used in a voting system using a token and a method thereof in accordance with an embodiment of the present disclosure.

### DETAILED DESCRIPTION

The specific structural or functional description disclosed herein is merely illustrative for the purpose of describing embodiments according to the concept of the present disclosure. The embodiments according to the concept of the present disclosure can be implemented in various forms, and cannot be construed as limited to the embodiments set forth herein.

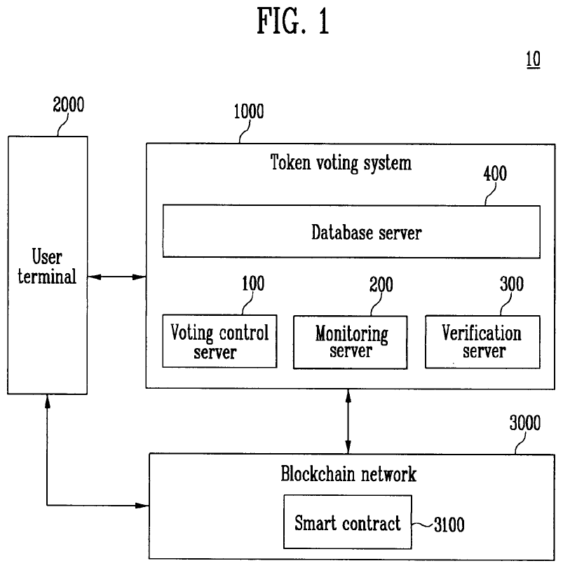

FIG. 1 is a diagram for explaining a configuration and operation of an electronic system in accordance with an embodiment of the present disclosure.

Referring to FIG. 1, an electronic system 10 may include a token voting system 1000, a user terminal 2000, and a blockchain network 3000.

The token voting system 1000 may be a system for voting using tokens minted on the blockchain network 3000. The token may include a non-fungible token (NFT) and a fungible token (FT) minted based on the information displayed on the tangible object.

In an embodiment of the present disclosure, a non-fungible token (NFT) and a non-transferable fungible token may be minted together on the blockchain network 3000. For example, one non-transferable fungible token may be minted for each non-fungible token on the blockchain network 3000. The non-transferable fungible token may be referred to as a COMO token, and the user may vote using the COMO token in the token voting system 1000.

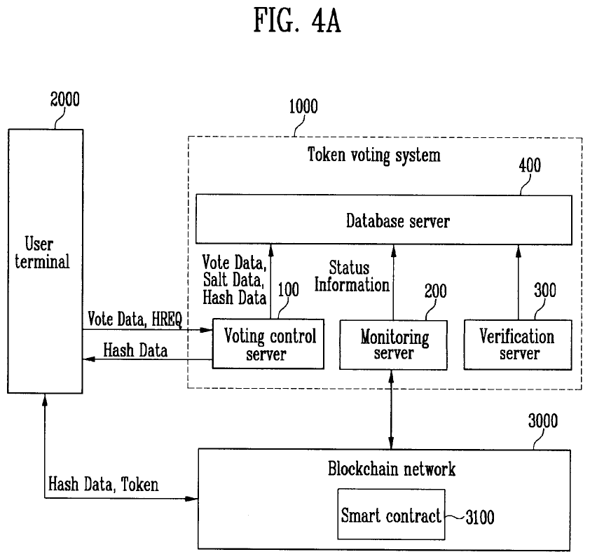

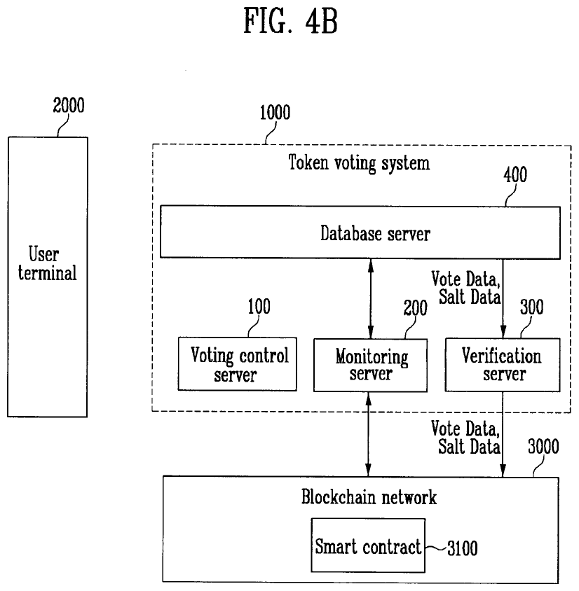

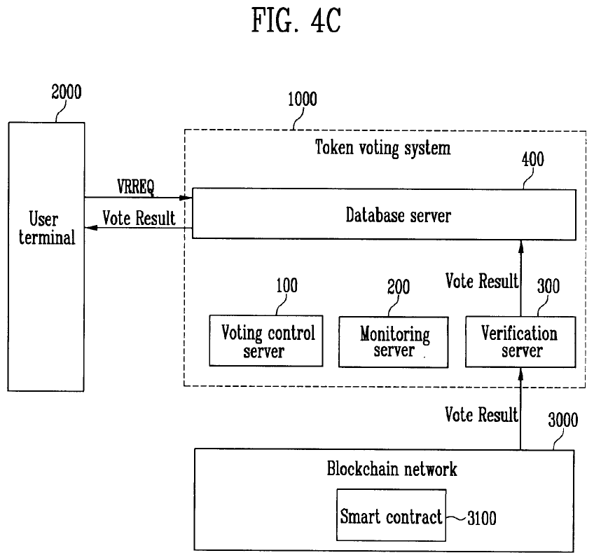

The token voting system 1000 may include a voting control server 100, a monitoring server 200, a verification server 300 and a database server 400. The voting control server 100 may process a voting request of the user terminal 2000. The voting control server 100 may include an application programming interface (API) server. The monitoring server 200 may monitor voting transactions of the user terminal 2000 occurring on the blockchain network 3000. The monitoring server 200 may include an indexer server. The verification server 300 may count the vote result on the smart contract 3100 of the blockchain network 3000 after voting ends. The verification server 300 may include a batch-job server. The database server 400 may store vote data received from the user terminal 2000, status information about the vote data, hash data, vote result received from the blockchain network 3000, and the like. The specific operation of the token voting system 1000 will be described later through FIGS. 4A to 4C.

The user terminal 2000 may include mobile phone, smart phone, laptop computer, digital broadcasting terminal, personal digital assistants (PDA), portable multimedia player (PMP), navigation, server device, and the like, but the user terminal 2000 may be other various devices capable of user input and information display.

Each user terminal 2000 may have a communication module for accessing the blockchain network 3000. The blockchain network 3000 may be implemented as a wired network, such as a local area network (LAN), a wide area network (WAN), or a value added network (VAN). In addition, the blockchain network 3000 may be implemented as all types of wireless networks such as a mobile radio communication network, a satellite communication network, Bluetooth, wireless broadband internet (Wibro), high speed downlink packet access (HSDPA), Wi-Fi, and long term evolution (LTE). If necessary, the blockchain network 3000 may be a network in which wired and wireless networks are mixed.

The blockchain network 3000 refers to a peer-to-peer (P2P) network composed of a plurality of blockchain nodes operating according to a blockchain algorithm (or protocol).

A transaction or blockchain transaction may refer to all actions that cause state changes (e.g., increase or decrease of balance, transfer of assets) in the block chain network 3000 or data indicating the actions. Transactions may include write-type transactions (e.g., transactions that add, modify, or delete state data). Depending on the blockchain network 3000, various types of transactions (e.g., execution) may exist in addition to the write type, and in such a case, the transaction may include all of the various types of transactions. Transactions may be executed through the smart contract 3100 (e.g., access to the blockchain through functions and variables defined in the smart contract 3100), but this may vary depending on the blockchain network 3000.

The smart contract 3100 refers to a script or software code used for transaction processing in the blockchain network 3000. More specifically, the smart contract 3100 is a code that programmatically writes actions according to various conditions, states, and conditions used in transaction processing, and for example, may include the smart contract 3100 of Ethereum, chain code of Hyperledger Fabric, and the like. The smart contract 3100 has the advantage of automatically executing requests according to business logic without third party intervention.

In the blockchain network 3000, the smart contract 3100 also has an address, which is usually called a contract address. When the smart contract 3100 commands to do certain task, the address that tells the location is the contract address. Therefore, the contract address of the smart contract 3100 of the token may be the address that tells the location when commanding to do certain task with respect to the corresponding token.

A personal blockchain wallet is a means of managing digital assets (e.g., coins or tokens), and transactions of digital assets occur in the blockchain network 3000, where a public key and a private key are used. The public key and private key have a password-like function, corresponding to the bank account number and internet banking login details, respectively, and the public key is a key shared with others for the purpose of receiving digital assets from private account, and the private key performs the same function as a key to a secret safe. The private key provides access to digital assets that are always stored on the blockchain network 3000. When a user creates (or sets, hereinafter referred to as ‘create’) a personal blockchain wallet (e.g., MetaMask), a public key and a private key are generated, and the exact amount of digital assets owned is displayed through interaction with the blockchain network 3000. The blockchain wallet can be said to be a bridge that connects digital assets existing on the blockchain network 3000 in the first place with users, and users can mint, purchase, sell, store, and use digital assets using a personal blockchain wallet. Here, the wallet address information of the personal blockchain wallet may be a private key or information modified thereof, and the approval information of the personal blockchain wallet (information used for actions such as electronic signature to execute a specific transaction) may be a secret key or information modified thereof.

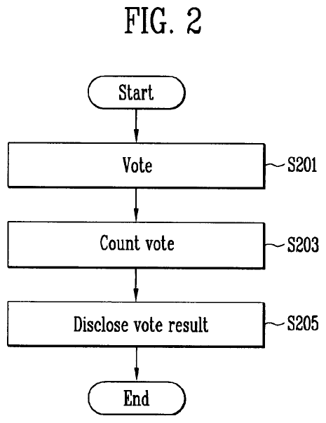

FIG. 2 is a flowchart for explaining a voting method using an electronic system.

Referring to FIGS. 1 and 2, the electronic system may include a user terminal, a voting token system, and a blockchain network.

In operation S201, voting using an electronic system may be performed.

For example, a user may provide vote data to the token voting system using the user terminal, and the token voting system may provide hash data to the user terminal. The user may vote for a desired option among a plurality of options by providing hash data and a token to the blockchain network through the user terminal.

In operation S203, vote data may be counted through the electronic system.

For example, the token voting system compares data stored in the blockchain network with data stored in the token voting system to check whether the user's vote has been omitted. The token voting system may verify vote data by providing vote data and salt data to the blockchain network if there is no vote omission. The blockchain network may determine whether the vote data is the correct data according to whether the hash data generated based on the vote data and salt data received from the token voting system matches the hash data received from the user terminal. The blockchain network may count the number of votes based on vote data determined as correct data.

In operation S205, the vote result may be disclosed through the electronic system.

For example, the blockchain network may provide the vote result to the token voting system once the counting of all vote data is complete. The token voting system stores the vote result and may set the status information of vote data to a finalized state. The user may receive a vote result from the token voting system through the user terminal and confirm the vote result.

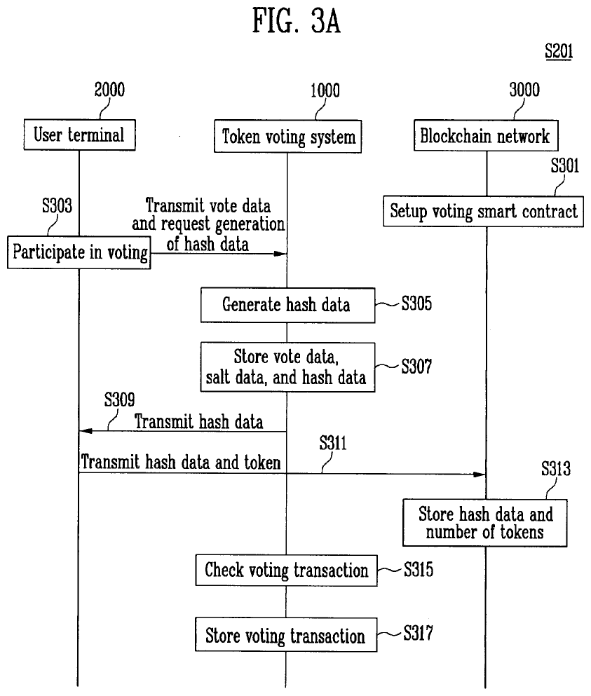

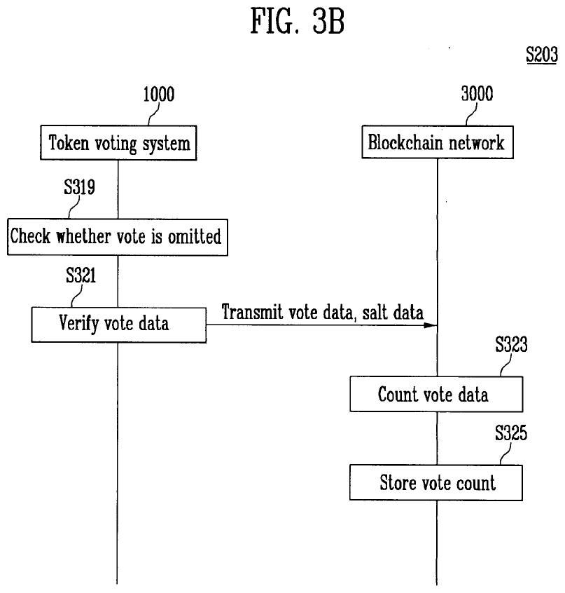

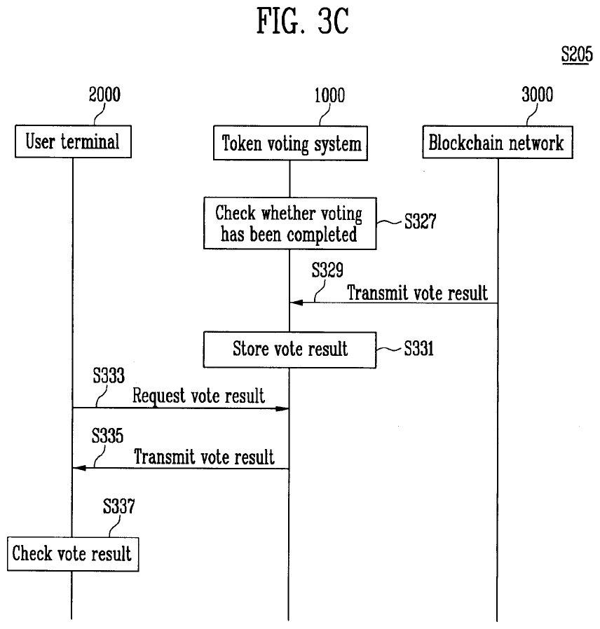

FIG. 3A is a flowchart for explaining a voting operation of FIG. 2 in detail.

Referring to FIG. 3A, in operation S301, the blockchain network 3000 may set up a voting smart contract. The voting smart contract may be a contract that collects, verifies, counts, and discloses vote data from the user terminal 2000 based on the blockchain network 3000.

In operation S303, the user terminal 2000 may participate in voting by transmitting vote data to the token voting system 1000 and requesting generation of hash data.

In operation S305, the token voting system 1000 may generate hash data based on the vote data and the salt data in response to the hash data generation request. The salt data may be random data for encryption.

In operation S307, the token voting system 1000 may store vote data, salt data, and hash data. At this time, the token voting system 1000 may also store status information related to vote data. Status information is information indicating the state of vote data according to voting progress stages, and may indicate any one of a created state, a committed state, and a finalized state of vote data. In operation S307, the initial value of status information may indicate a created state.

In operation S309, the token voting system 1000 may transmit hash data to the user terminal 2000.

In operation S311, the user terminal 2000 may transmit hash data and a token to the blockchain network 3000. The token may be a token minted to the blockchain network 3000 based on token identification information displayed on a tangible object (ex. physical card).

In operation S313, the blockchain network 3000 may store the hash data received from the user terminal 2000, and may count and store the number of non-fungible tokens.

In operation S315, the token voting system 1000 may check the voting transaction generated by the user terminal 2000 transmitting the token to the blockchain network 3000. At this time, the token may be referred to as a COMO token as a non-transferable fungible token.

In operation S317, the token voting system 1000 may store the voting transaction when the voting transaction is normally checked. The token voting system 1000 may store a check result that the voting transaction was normally performed by setting the status information of the vote data from created state to committed state.

FIG. 3B is a flowchart for explaining a vote counting operation of FIG. 2 in detail.

Referring to FIG. 3B, in operation S319, the token voting system 1000 may check whether there is an omission of a vote. The token voting system 1000 may check whether a vote is omitted by comparing the number of vote data stored in the token voting system 1000 with the number of tokens stored on the blockchain network 3000. The token voting system 1000 may determine that there is no omission of a vote when the number of vote data stored in the token voting system 1000 and the number of tokens stored on the blockchain network 3000 match.

In operation S321, the token voting system 1000 may verify the vote data by providing vote data and salt data to the blockchain network 3000 if there is no vote omission.

In operation S323, the blockchain network 3000 may determine whether the vote data is the correct data according to whether the hash data generated based on the vote data and salt data received from the token voting system 1000 matches the hash data received from the user terminal 2000. When the two hash data match each other, the blockchain network 3000 may determine the vote data as correct data and count the number of votes based on the corresponding vote data.

In operation S325, the blockchain network 3000 may calculate the number of votes for each of a plurality of options and store it as a vote count.

FIG. 3C is a flowchart for specifically explaining a vote result disclosing operation of FIG. 2.

Referring to FIG. 3C, in operation S327, the token voting system 1000 may check whether voting has been completed. When the counting of all vote data is completed, the token voting system 1000 may request a vote result from the blockchain network 3000.

In operation S329, the blockchain network 3000 may provide the vote result to the token voting system 1000 when the counting of vote data is completed.

In operation S331, the token voting system 1000 may set the status information on the vote data to a finalized state and store the vote result.

In operation S333, the user terminal 2000 may request the vote result from the token voting system 1000.

In operation S335, the user terminal 2000 may receive the vote result from the token voting system 1000.

In operation S337, the user terminal 2000 may check the received vote result.

FIG. 4A is a diagram for explaining an operation of a token voting system in a voting operation.

Referring to FIG. 4A, the voting control server 100 may receive a voting request and vote data from the user terminal 2000. Vote data may include data corresponding to an option determined by the user terminal 2000 among a plurality of options. The voting control server 100 may generate hash data based on the vote data in response to the hash data generation request (HREQ) included in the voting request. The voting control server 100 may generate hash data by inputting vote data and salt data to a hash algorithm. Salt data may be random data for encryption.

The voting control server 100 may provide hash data to the user terminal 2000. The voting control server 100 may store vote data, salt data, and hash data in the database server 400. The voting control server 100 may also store status information related to vote data in the database server 400 together. The status information may be information indicating the status of vote data according to the voting progress stage. The status information may indicate any one of a created state, a committed state and a finalized state of vote data. When the vote data is stored in the database server 400, the initial value of the status information may indicate the created state.

The monitoring server 200 may check a transaction in which the user terminal 2000 transmits hash data and a token to the blockchain network 3000. When the voting transaction is normally checked, the monitoring server 200 may store the voting transaction. The monitoring server 200 may store the check result indicating that the voting transaction was normally performed by setting the status information of the vote data from created state to committed state.

The verification server 300 may verify vote data stored in the database server 400 on the blockchain network 3000.

The database server 400 may store vote data, status information about the vote data, salt data, and hash data.

The user terminal 2000 may provide the hash data received from the voting control server 100 to the blockchain network 3000 together with the token.

Information about the token may include digital content information and token identification information. The token identification information may include uniform resource locator (URL) information indicating an address where the token is stored. Token identification information may be visualized and displayed on tangible objects. For example, token identification information may be converted into a barcode or QR code and displayed on a tangible object. The tangible object may include a physical card.

The blockchain network 3000 may count and store the number of tokens received from the user terminal 2000 together with hash data on the smart contract 3100.

FIG. 4B is a diagram for explaining an operation of a token voting system in a vote counting operation.

Referring to FIG. 4B, the monitoring server 200 may check whether there is an omission of a vote by comparing data stored in the blockchain network 3000 and the database server 400, respectively. For example, the monitoring server 200 may compare the number of vote data stored in the database server 400 with the number of tokens stored on the smart contract 3100 of the blockchain network 3000 to check whether a vote is omitted. The monitoring server 200 may determine that the vote is not omitted when the number of vote data and the number of tokens match.

The verification server 300 may verify the vote data by providing the vote data and salt data received from the database server 400 to the blockchain network 3000 when there is no vote omission.

The blockchain network 3000 may determine whether the vote data is correct data depending on whether the hash data generated based on the vote data and salt data received from the verification server 300 matches the existing hash data received from the user terminal 2000. When the two hash data match each other, the blockchain network 3000 may determine the vote data as correct data and count the number of votes based on the corresponding vote data.

FIG. 4C is a diagram for explaining an operation of a token voting system in a vote result disclosing operation.

Referring to FIG. 4C, the blockchain network 3000 may provide a vote result to the verification server 300 when the counting of all vote data is completed. The verification server 300 may store the vote result received from the blockchain network 3000 in the database server 400 and set the status information of the vote data to a finalized state.

The user terminal 2000 may provide the vote result request VRREQ to the database server 400. The database server 400 may provide the vote result to the user terminal 2000 in response to the vote result request VRREQ. The user may confirm the vote result received from the database server 400 through the user terminal 2000.

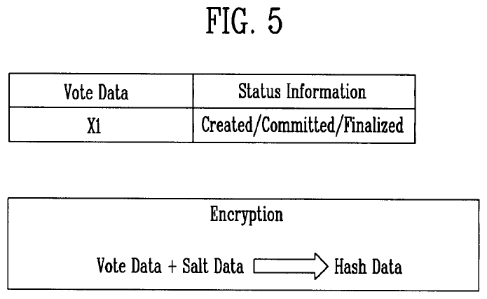

FIG. 5 is a diagram for explaining vote data, salt data, hash data, and status information in accordance with an embodiment of the present disclosure.

Referring to FIG. 5, the vote data may include data corresponding to an option determined by the user terminal among a plurality of options. In FIG. 5, the value of vote data may be X1. X1 may be a number, a character string, or a combination thereof.

Status Information may indicate any one of a created state, a committed state, and a finalized state of vote data. The initial value of status information may indicate a created state.

Hash data may be generated based on vote data and salt data. Salt data may be random data for encryption.

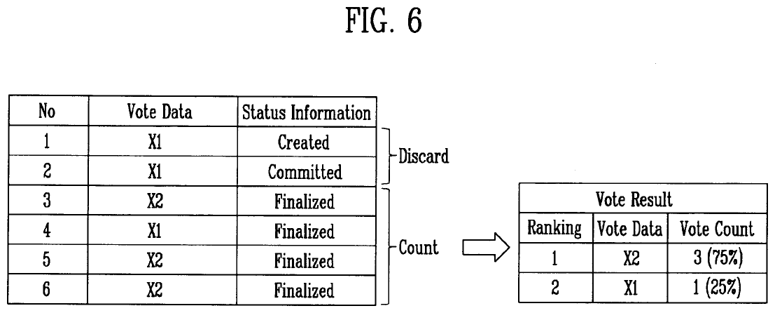

FIG. 6 is a diagram for explaining a vote result in accordance with an embodiment of the present disclosure.

Referring to FIG. 6, among a plurality of vote data, the number of vote data having a vote data value of X1 may be three, and the number of vote data having X2 may be three.

Looking at the status information of the vote data, the first vote data may be vote data in a created state where a transaction in which the user terminal transmits a token to the blockchain network is not checked although it is stored in the database server of the token voting system.

The second vote data may be vote data in a committed state where it is stored in the database server of the token voting system and a transaction in which the user terminal transmits a token to the blockchain network is checked. However, the second vote data may be fraudulent vote data in which the hash data transmitted by the user terminal to the blockchain network and the hash data generated based on the vote data and salt data stored in the database server do not match each other. Since fraudulent vote data is not counted, it may not be set to a finalized state.

The third to sixth vote data may be vote data stored in the database server of the token voting system and a transaction in which the user terminal transmits a token to the blockchain network is checked. In addition, the hash data transmitted by the user terminal to the blockchain network, and the hash data generated based on the vote data and salt data stored in the database server may match each other to be correct vote data. Correct vote data may be normally counted and set to a finalized state.

In FIG. 6, in the case of original vote data, the number of vote data having a vote data value of X1 is 3 and the number of vote data having X2 is 3, but since the vote result includes only vote data set to a finalized state, it may be counted that the number of vote data having a vote data value of X1 is 1, and the number of vote data having X2 value is 3.

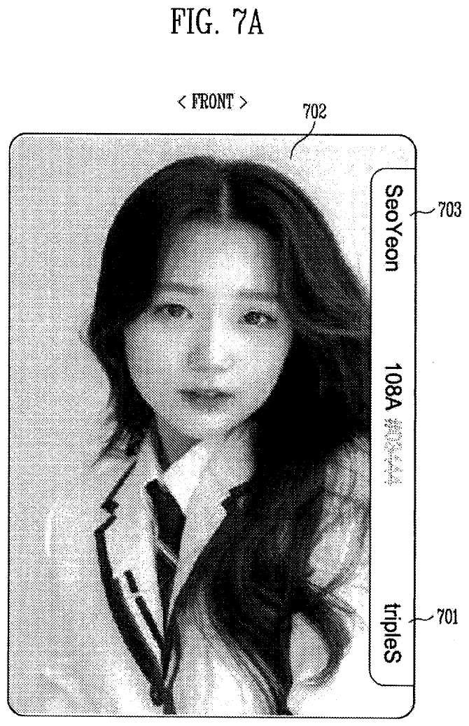

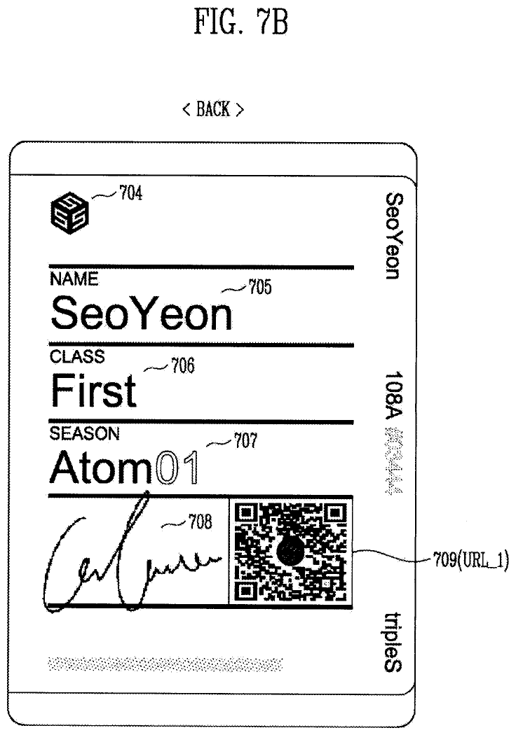

FIGS. 7A and 7B are diagrams for explaining a front side (FIG. 7A) and a back side (FIG. 7B) of a tangible object (physical card) used in a voting system using a token and a method thereof in accordance with an embodiment of the present disclosure.

FIGS. 7A and 7B illustrate a case in which a token managed by the method and system for transmitting a token according to an embodiment of the present disclosure is a token related to an idol group.

As shown in FIG. 7A, name 701 of the idol group, a photo 702 of a member of the idol group, and name 703 of the idol group member displayed on the corresponding photo may be displayed on the front side (FRONT) of the tangible object (physical card). Information displayed on the front side (FRONT) of the tangible object (physical card) may be information included in digital content information of the token.

As shown in FIG. 7B, on the back side (BACK) of the tangible object (physical card), a mark 704 of the idol group, name 705 of the idol group member, a class 706 of a randomly determined token, a minting season 707, a autograph 708 of the idol group member and URL information (URL_1) in the form of a QR code 709 among information included in the token information (NFT_1) may be displayed. The URL information may include an Internet address for downloading an application that must be installed in the user terminal in order to use the token transmission system and a token serial number of the token.

In FIGS. 7A and 7B, although the case in which information corresponding to digital content information among information included in token information is displayed on the front side (FRONT) and the back side (BACK) of the tangible object (physical card), and the token address information (URL_1) is converted to a QR code and displayed on the back side (BACK) of the tangible object (physical card) is shown, information displayed on the front side (FRONT) and back side (BACK) of the tangible object (physical card) may be selected in various ways.

When the user activates the application on the smartphone and recognizes the QR code 709 displayed on the back side (BACK) of the tangible object (physical card) of FIG. 7A with the camera, the token transmission system may mint a token corresponding 1:1 to the tangible object (physical card) on the blockchain network. In addition, the user may transmit the token corresponding 1:1 to the tangible object (physical card) from one user's blockchain wallet to another user's blockchain wallet, by a method in which the user enters another user's nickname while activating the application on the smartphone, or by a method in which a user other than the user who has minted and owns the above token recognizes the QR code 709 displayed on the back side (BACK) of the tangible object (physical card) with a camera while activating the application on his/her smartphone, and the user who has minted and owns the above token allows the transmission from his/her smartphone.

Tokens minted on the blockchain network and transferred from another user's blockchain wallet may include non-fungible tokens or fungible tokens.

In an embodiment of the present disclosure, one non-transferable fungible token may be minted per non-fungible token on a blockchain network. Non-transferable fungible tokens may be referred to as COMO tokens, and users may vote using COMO tokens. The operation of the method according to the embodiment of the present disclosure can be implemented as a computer readable program or code on a computer-readable recording medium. A computer-readable recording medium includes all types of recording devices storing data that can be read by a computer system. In addition, computer-readable recording media may be distributed to computer systems connected through a network to store and execute computer-readable programs or codes in a distributed manner.

In addition, the computer-readable recording medium may include hardware devices specially configured to store and execute program instructions, such as ROM, RAM, and flash memory. The program instructions may include high-level language codes that can be executed by a computer using an interpreter or the like as well as machine code generated by a compiler.

Although some aspects of the present disclosure have been described in the context of an apparatus, it may also represent a description according to a corresponding method, where a block or apparatus corresponds to a method step or feature of a method step. Similarly, aspects described in the context of a method may also be represented by a corresponding block or item or a corresponding feature of an apparatus. Some or all of the method steps may be performed by (or using) a hardware device such as, for example, a microprocessor, programmable computer or electronic circuitry.

### EXPLANATION OF REFERENCE NUMERALS

10: Electronic system
100: Voting control server
200: Monitoring server
300: Verification server
400: Database server
1000: Token voting system
2000: User terminal
3000: Blockchain network
3100: Smart contract

What is claimed is:

1. A token voting system using a blockchain network, the token voting system comprising:
a voting control server configured to generate hash data based on vote data received from a user terminal in response to a voting request of the user terminal, and provide the hash data to the user terminal;
a database server configured to store the vote data, status information about the vote data, and the hash data;
a monitoring server configured to check a transaction generated by the user terminal transmitting the hash data and a token to the blockchain network, and set the status information according to a check result of the transaction; and
a verification server configured to verify the vote data stored in the database server on the blockchain network.

2. The token voting system of claim 1, wherein the voting control server is configured to, in response to the voting request, generate the hash data using the vote data and salt data, and store the salt data in the database server.

3. The token voting system of claim 2, wherein the vote data comprises data corresponding to an option determined by the user terminal among a plurality of options, and
the salt data comprises random data for encryption.

4. The token voting system of claim 1, wherein the status information indicates any one of a created state, a committed state, and a finalized state of the vote data.

5. The token voting system of claim 4, wherein the voting control server is configured to, when the vote data is stored in the database server, set the status information to the created state.

6. The token voting system of claim 4, wherein the monitoring server is configured to, when the transaction is checked, set the status information to the committed state.

7. The token voting system of claim 4, wherein the verification server is configured to, when a counting of the vote data is completed in the blockchain network, set the status information to the finalized state.

8. The token voting system of claim 1, wherein the monitoring server is configured to compare data stored in each of the blockchain network and the database server to check whether there is an omission of a vote.

9. The token voting system of claim 8, wherein the verification server is configured to, if there is no omission of the vote, provide the vote data received from the database server and salt data to the blockchain network to verify the vote data.

10. The token voting system of claim 9, wherein the verification server is configured to, when a counting of the vote data is completed in the blockchain network, receive a vote result from the blockchain network and store the vote result in the database server.

11. The token voting system of claim 10, wherein the database server is configured to provide the vote result to the user terminal in response to a vote result request received from the user terminal.

12. The token voting system of claim 1, wherein information about the token comprises digital content information and token identification information.

13. The token voting system of claim 12, wherein the token identification information is visualized and displayed on a tangible object.

14. The token voting system of claim 13, wherein the token identification information is converted into a barcode or QR code and displayed on the tangible object.

15. The token voting system of claim 13, wherein the token identification information comprises uniform resource locator (URL) information indicating an address where the token is stored.

16. An operating method of a token voting system using a blockchain network, the operating method comprising:
generating hash data based on vote data received from a user terminal in response to a voting request of the user terminal;
storing the vote data, status information about the vote data, and the hash data in a database server;
providing the hash data to the user terminal;
checking a transaction generated by the user terminal transmitting the hash data and a token to the blockchain network; and
setting the status information according to a check result of the transaction.

17. The operating method of claim 16, wherein the generating of the hash data comprises generating the hash data using the vote data and salt data for encryption, and
the vote data comprises data corresponding to an option determined by the user terminal among a plurality of options.

18. The operating method of claim 16, wherein the status information indicates any one of a created state, a committed state, and a finalized state of the vote data.

19. The operating method of claim 18, wherein the status information is set to the created state when the vote data is stored.

20. The operating method of claim 18, wherein the status information is set to the committed state when the transaction is checked.

21. The operating method of claim 18, wherein the status information is set to the finalized state when a counting of the vote data is completed in the blockchain network.

22. The operating method of claim 16, further comprising:
comparing data stored in each of the blockchain network and the database server to check whether there is an omission of a vote.

23. The operating method of claim 22, further comprising:
if there is no omission of the vote, verifying the vote data by providing the vote data and salt data to the blockchain network.

24. The operating method of claim 23, further comprising:
when a counting of the vote data is completed in the blockchain network, receiving a vote result from the blockchain network;
storing the vote result in the database server; and
providing the vote result to the user terminal in response to a vote result request received from the user terminal.

25. The operating method of claim 16, wherein information about the token comprises digital content information and token identification information visualized and displayed on a tangible object.

26. The operating method of claim 25, wherein the token identification information is converted into a barcode or QR code and displayed on the tangible object.

27. The operating method of claim 25, wherein the token identification information comprises uniform resource locator (URL) information indicating an address where the token is stored.

28. An operating method of an electronic system comprising a user terminal, a blockchain network and a token voting system, the operating method comprising:
providing, by the user terminal, vote data to the token voting system;
generating, by the token voting system, hash data based on the vote data and salt data;
storing, by the token voting system, the vote data, status information about the vote data, and the hash data;
providing, by the token voting system, the hash data to the user terminal;
performing, by the user terminal, a transaction for transmitting the hash data and a token to the blockchain network;
storing, by the blockchain network, the hash data and the number of tokens; and
checking the transaction and setting the status information according to a check result of the transaction, by the token voting system.

29. The operating method of claim 28, further comprising:
checking, by the token voting system, whether there is an omission of a vote by comparing the number of tokens stored on the blockchain network with the number of vote data stored in the token voting system;
verifying, by the token voting system, the vote data by providing the vote data and the salt data to the blockchain network if there is no omission of the vote; and
counting, by the blockchain network, the number of votes based on the vote data, when hash data generated based on the vote data and the salt data received from the token voting system and the hash data received from the user terminal match.

30. The operating method of claim 29, further comprising:
providing, by the blockchain network, a vote result to the token voting system, when a counting of all vote data is completed; and
checking, by the user terminal, the vote result by receiving the vote result from the token voting system.

31. The operating method of claim 28, wherein the status information indicates any one of a created state, a committed state, and a finalized state of the vote data, and
the token voting system is configured to, when the vote data is stored, set the status information to the created state, when the transaction is checked, set the status information to the committed state, and when a counting of the vote data is completed, set the status information to the finalized state.

32. The operating method of claim 28, wherein information about the token comprises digital content information and token identification information visualized and displayed on a tangible object, and wherein the token identification information comprises uniform resource locator (URL) information indicating an address where the token is stored.
